(19) United States
(12) Patent Application Publication
(10) Pub. No.: US 2003/0147072 A1
(43) Pub. Date: Aug. 7, 2003

(54) Laser spectroscopic remote detection of surface contamination

(76) Inventor: Andrew I. Whitehouse, Skipton (GB)

Correspondence Address: SHERIDAN ROSS PC, 1560 BROADWAY, SUITE 1200, DENVER, CO, 80202

(21) Appl. No.: 10/220,679

(22) PCT Filed: Mar. 1, 2001
(86) PCT No.: PCT/GB01/00866

(30) Foreign Application Priority Data
Mar. 4, 2000 (GB) 0005180.5

(51) Int. Cl. G01N 21/63

(52) U.S. Cl. 356/318; 356/313; 356/316

(57) ABSTRACT

A method of detecting the presence of radioactive waste material (11) on the surface of a storage drum (10), wherein Laser Induced Breakdown Spectroscopy techniques are used to obtain electronic emission spectra characteristic of the waste material (11) where this is present on the surface of the drum (10). Because electronic emission spectra are not affected by the strong background nuclear radiation from the waste material contained within the drum (10), a much improved accuracy of detection is achieved.

The present invention relates to the detection of surface contamination by use of laser spectroscopic techniques, and in particular, but not exclusively, to the detection of vitrified nuclear waste on the outsides of nuclear waste storage containers.

Nuclear waste arising from nuclear reprocessing, spent fuel management and decommissioning operations is generally, after appropriate segregation and conditioning, stored in suitable receptacles such as stainless steel drums. These drums are designed to contain the waste in such a way as to hinder the spread of nuclear contamination to other materials which may come into contact with the drums, such as the inside surfaces of nuclear transport flasks and other plant and equipment used to process the contained waste or to handle the drums. Significant safety and operational problems and additional costs would result from the spread of nuclear contamination should the drums fail adequately to contain the waste. Considerable effort is spent in the industry to ensure that the waste drums are hermetically sealed to prevent egress of the contained waste. However, when the drums are being filled with waste, there is a risk that the outside surfaces of the drums may become contaminated through spillage or other means, and this contamination must be removed before the drums are transported to a storage facility. For Intermediate Level Waste (ILW) and High Level Waste (HLW), radiometric monitoring of the external surface of each drum is not usually able to distinguish between the gamma nuclear radiation emitted by the contained waste and that due to any surface contamination.

For ILW and HLW drums, the nuclear industry standard method of detecting the presence of surface contamination is to use a robot swabbing system. A swab is wiped around the exterior surface of each drum by a remote controlled robot so as to pick up at least a fraction of any contamination which may be present, and the swab is then removed to another location for radiometric monitoring. This is time-consuming and prone to errors, since the swabs must be matched to the drums even when the swabs are removed for analysis, since there is no provision for an instant in situ analysis of possible contamination. Furthermore, this process is only effective for loose contamination, as any contamination which has become fixed to the outside surfaces of the drums will not, of course, be picked up by the swabs. This is of particular concern when processing HLW for storage, since such waste is often blended with molten glass to form a vitrified product. The molten blend of glass and waste is then poured into stainless steel drums and, after a period to allow for cooling, the drums are sealed by welding lids thereon. During this operation, small but significant quantities of the vitrified product may become strongly adhered to the outside surfaces of the drums as a result of deficiencies in the pouring process. The vitrified product is highly radioactive and may cause serious contamination should it later become detached from the outsides of the drums and escape into the environment during subsequent handling of the drums. Conventional robotic swabbing of the drums is unable to detect the presence of such contamination which is strongly adhered to the outsides of the drums. Indeed, the present applicant is unaware of any known technique which may be used reliably to detect the presence of such “fixed” contamination on outer surfaces of ILW and HLW storage drums.

According to the present invention, there is provided a method of detecting the presence of a radioactive contaminant on a container for the storage of radioactive waste materials, wherein a laser is directed onto the container so as to generate a luminous plasma or spark, and wherein light from the luminous plasma or spark is collected and directed towards a spectroscope, where the light is analysed for the presence of predetermined atomic emission spectra arising from electronic transitions and which are characteristic of the radioactive contaminant.

Because the method of the present invention seeks to detect the presence of radioactive materials by their electronic emission spectra through the use of an atomic emission spectroscopy (AES) technique rather than by radiometric analysis, strong levels of background nuclear radiation such as those due to the presence of nuclear waste inside storage drums, do not interfere with the detection process. In the present application, the term “radioactive materials” encompasses radioactive elements and compounds as well as a carrier medium in which such elements and compounds may be dispersed. The method of the present invention may be used to detect electronic emission spectra (caused by electronic transitions) characteristic of the radioactive elements or compounds themselves, or may be used to detect emission spectra characteristic of a carrier medium in which the radioactive elements or compounds are dispersed, such as glass, ceramics or other materials, thereby using inference to determine the presence of radioactive elements or compounds.

The laser is advantageously a pulsed laser, since the very high intensities of laser energy required for plasma formation are more readily achieved by such a laser. In order to form a plasma, a typical peak laser intensity of around 10 to 1000 MWcm⁻² is required. For a given average power laser, it is much easier to achieve plasma formation using a pulsed rather than a continuous wave laser. For example, a Q-switched Nd:YAG laser, having a typical pulse length of 10 nanoseconds and generating 100 mJ of energy per pulse, can readily produce a plasma on the surface of a material by simple focussing of the laser light. Assuming such a laser operates at a pulse repetition rate of, say, 10 Hz, then the average power is 1W while the instantaneous peak power is 100×10⁻³J/10×10⁻⁹s=10 MW. The low average power of the laser means that there is little thermal interaction with the target material, thus helping to avoid damage thereto. This is particularly important where the target area is the surface of a waste drum as hereinbefore discussed.

In a preferred embodiment, the laser is a Q-switched Nd:YAG laser, although other suitable lasers may be used, and the preferred spectroscopic technique employed in the invention is Laser-Induced Breakdown Spectroscopy (LIBS). A Q-switched Nd:YAG laser is particularly suitable for use with the present invention because it can easily be configured to produce various outputs. For example, it is possible to include frequency multiplying (e.g. doubling, tripling or quadrupling) modules which can convert a standard fundamental wavelength of 1064 nm into 532 nm (doubled), 354 nm (tripled) or 266 nm (quadrupled). 1064 nm is in the near infra red region of the electromagnetic spectrum, 532 nm is in the visible region (green light), 354 nm is in the near ultraviolet region and 266 nm is in the far ultraviolet region. Any of these wavelengths may be used in LIBS applications. However, the hazards to operating personnel of high power laser light are well documented, and the Q-switched Nd:YAG laser is known to be particularly hazardous to the eyes and skin We have found that the fundamental and doubled frequency wavelengths (1064 nm and 532 nm respectively) are readily transmitted through nuclear radiation shielding windows in typical nuclear installation hot-cells, even though these windows may be up to 2 m thick. Stray laser light from generated plasmas could, therefore, pose a significant hazard to operating personnel monitoring the process of the present invention through such a window, especially if those personnel do not wear safety glasses. For safety reasons, therefore, it is preferred to use ultraviolet laser light (e.g. tripled or quadrupled frequency), since the window material is generally opaque to ultraviolet wavelengths and scattered laser light will, therefore, be attenuated to a sufficient degree to provide improved safety for the operating and other personnel in the immediate vicinity.

The spectroscope may be a high-resolution optical spectrograph, advantageously connected to computer analysis means such as a personal computer (PC) including an appropriate spectroscopic analysis program. The laser is preferably directed to the target areas by way of a light guide, such as an optical fibre link or an arrangement of mirrors, from a remote location which is shielded from nuclear radiation. The same light guide may be used to collect and return spectroscopic data to the spectroscope, which is preferably also located remote from the target areas, or a separate light guide may be provided. By using a light guide, it is possible for an operator to perform the steps of the present invention from a safe location which is shielded from the nuclear radiation emanating from the target areas. In a particularly preferred embodiment, the light guide is an ultraviolet-grade quartz endoscope, since this will facilitate the transmission of ultraviolet laser light, which is preferred for safety reasons as hereinbefore discussed.

The method of the present invention is particularly suitable for detecting the presence of vitrified nuclear waste on the outside surface of a waste drum as hereinbefore discussed. A light guide is fed from a safe location to the location where the drums are being filled with waste, and laser light is directed onto the outside of each drum, ideally in such a way as to scan the entire outside surface thereof The laser light generates a luminous plasma or spark on the surface of the drum or on nuclear waste which has become adhered thereto, and light from the luminous plasma or spark is then directed back along the light guide to a spectroscope for analysis. The presence of vitrified nuclear waste on the surface of a drum is easily detected in situ by looking for spectral peals characteristic of either the elemental composition of the nuclear waste itself or, preferably, characteristic of the glass in which the nuclear waste is distributed. For example, sodium/lithium glass is often used in the vitrification of nuclear waste, and detection of characteristic sodium and/or lithium electronic emission spectra by the LIBS technique provides a strong inference of the presence of nuclear waste material without being influenced by the strong background nuclear radiation emanating from the vitrified waste contained within each drum, as would be the case with radiometric analysis. For instance, the orange sodium emission line at approximately 590 nm is easy to detect and difficult to confuse with other emission lines caused by the materials of the drum itself (which is typically made out of stainless steel).

Through appropriate choice of laser energy, laser spot size on the target area and focussing conditions (i.e. target intensities and fluence), it is possible to generate a LIBS electronic spectral signal from surface deposits such as vitrified nuclear waste without generating a signal from an underlying substrate such as the surface of a stainless steel waste drum. This firstly helps to reduce or eliminate unwanted spectral interference from the substrate (such as iron and chrominum atomic and ionic emission lines) and secondly helps to reduce damage to the substrate through unnecessary plasma generation. When selecting the appropriate operating parameters for the laser, the difference between the laser ablation threshold intensities of the surface deposits and the substrate is taken into account. In general, materials such as steel require a relatively high laser intensity to create ablation of the material, whereas materials such as vitrified nuclear waste generally have a lower ablation threshold intensity.

Although reference is made in the present application to surface contamination of nuclear waste drums, it will be appreciated that the method of the present invention can be used to detect surface contamination on various other substrates, including general plant and equipment which may have been exposed to contamination by nuclear waste within a nuclear installation. For example, when decommissioning an ILW or HLW nuclear processing plant, it may be important to scan for and detect stray fragments of vitrified waste which may be spread around within the plant in the area where waste is handled.

Through appropriate control of the laser, it is possible to remove surface contamination by way of laser ablation, a technique documented for example in U.S. Pat. No. 5,042,947 in the context of cleaning scrap metal. Specifically, by increasing the laser intensity appropriately, it is possible to vaporise and remove the surface contamination from the substrate.

For a better understanding of the present invention and to show how it may be carried into effect, reference shall now be made by way of example to the accompanying drawings, in which:

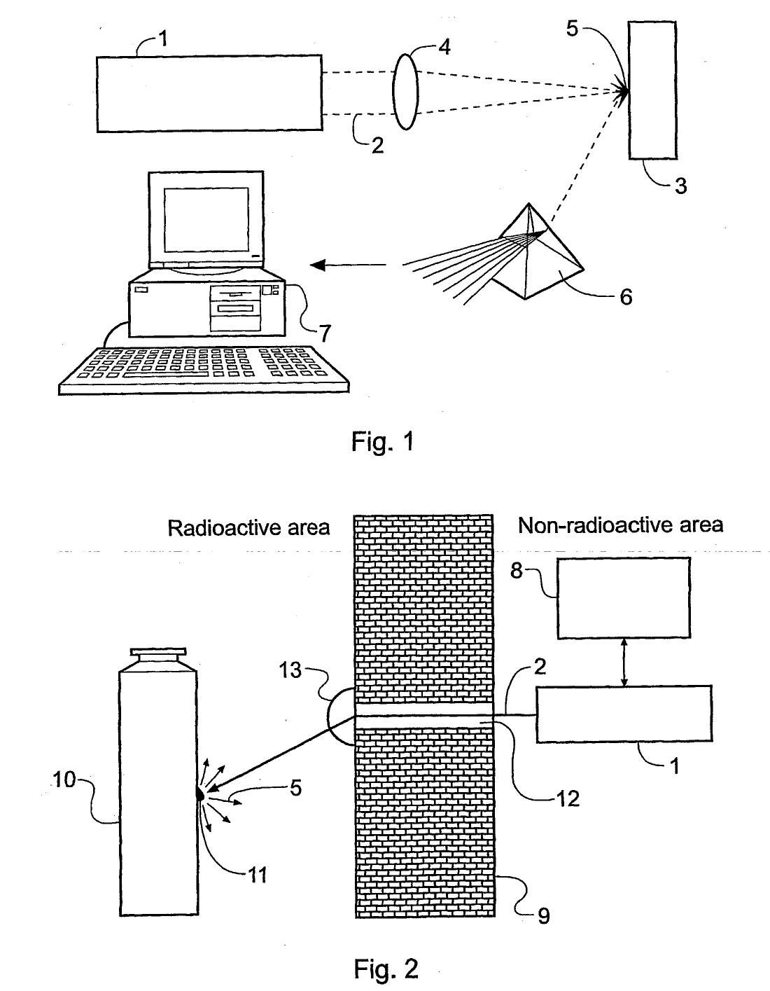

FIG. 1 shows in schematic form the principles behind Laser Induced Breakdown Spectroscopy; and

FIG. 2 shows schematically the use of the present invention to monitor contamination on the outside surface of a waste drum.

FIG. 1 shows a pulsed Q-switched Nd:YAG laser 1 being used to generate a laser beam 2 which is focussed onto a target material 3 by way of a focussing lens 4. A luminous microplasma 5 is generated where the laser beam 2 focuses onto the target material 3, and a fraction of the light from the microplasma 5 is then spectrally split by way of a spectroscope 6 and analysed by a computer 7.

In FIG. 2, there is shown in schematic form a pulsed Q-switched Nd:YAG laser 1 operatively linked to a spectroscopic analysis device 8 comprising a spectroscope and a computer (not shown), all located on one side of a nuclear radiation shielding wall 9. On the other side of the wall 9, stainless steel waste drums 10 are filled with nuclear waste mixed with molten glass, a portion of which 11 has spilled and adhered to an outer surface of the drum 10. Laser light 2 from the laser 1 is guided through the wall 9 by way of a quartz endoscope 12 and laser beam steering optics 13 which are controlled by the spectroscopic analysis device 8. By controlling the steering optics 13 and optionally rotating or otherwise moving the drum 10, it is possible to scan the entire outer surface thereof with the laser light 2. Where the laser light 2 impinges on the surface of the waste drum 10 or onto spilled portions 11 of vitrified nuclear waste, a spark or microplasma 5 is generated. A fraction of the light from the spark or microplasma 5 is then directed back along the quartz endoscope 12 to the spectroscopic analysis device 8 where the light is spectrally split and analysed for emission peaks characteristic of the glass in which the nuclear waste is dispersed, such as a strong sodium emission peak at around 590 nm. Because it can be fairly assumed that the dispersion of nuclear waste in the molten glass is relatively uniform, detection of glass traces on the outside of the drum 10 is strongly indicative of the presence of radioactive nuclear waste. By looking for electronic emission spectra characteristic of the glass rather than looking for ionising nuclear radiation characteristic of the nuclear waste, it is possible to infer the presence of vitrified nuclear waste outside the drum 10 without having to distinguish between ionising emissions from the spilled waste and the waste contained within the drum 10. Because the laser 1 and the spectroscopic analysis device 8 are both located in a safe region on the shielded side of the wall 9, they may easily be operated and maintained by a human operator. The quartz endoscope 12 and the beam steering optics 13 may be built in to the wall 9 upon initial construction, thereby allowing a completely remote analysis of the drums 10 to be achieved without risk of operator contamination. Alternatively, the endoscope 12 and beam steering optics 13 may be fed through a hole provided in the wall 9 when analysis is required.

1. A method of detecting the presence of a radioactive contaminant on a container for the storage of radioactive waste materials, wherein a laser is directed onto the container so as to generate a luminous plasma or spark, and wherein light from the luminous plasma or spark is collected and directed towards a spectroscope, where the light is analysed for the presence of predetermined atomic emission spectra arising from electronic transitions and which are characteristic of the radioactive contaminant.

2. A method according to claim 1, wherein the laser is a pulsed laser.

3. A method according to claim 2, wherein the laser is a Q-switched Nd:YAG laser.

4. A method according to any preceding claim, wherein the laser is directed onto the container from a remote location by way of a light guide.

5. A method according to any claim 4, wherein the laser is steerable by way of optical beam steering means.

6. A method according to any preceding claim, wherein the presence of the radioactive contaminant is determined by detecting the presence of electronic emission spectra characteristic of radioactive elements or compounds included in the radioactive contaminant.

7. A method according to any preceding claim, wherein the radioactive contaminant comprises radioactive elements or compounds dispersed in a carrier medium, and wherein the presence of the radioactive contaminant is inferred by detecting the presence of electronic emission spectra characteristic of the carrier medium.

8. A method according to claim 7, wherein the carrier medium is glass.

9. A method according to claim 8, wherein the presence of the radioactive contaminant is inferred by detecting the presence of a sodium emission line at around 590 nm.

10. A method according to any preceding claim, wherein spectroscopic analysis is performed on an outside surface of the container after the container has been filled with radioactive material.

11. A method according to any preceding claim, wherein the laser is adapted to produce ultraviolet laser light.

12. A method according to claim 11, wherein the laser is adapted to produce laser light having a wavelength of 354 nm or 266 nm.

13. A method according to any preceding claim, wherein the container comprises a substrate having surface contamination thereon, the substrate having a first laser ablation threshold intensity and the surface contamination having a second, relatively lower, laser ablation threshold intensity, and wherein operating parameters of the laser are chosen so as to cause selective plasma formation from the surface contamination and not from the substrate.

14. A method according to any preceding claim, wherein the container comprises a substrate having surface contamination thereon, and wherein the laser is operable to remove the surface contamination by way of laser ablation.
